(19) United States
(12) Patent Application Publication
(10) Pub. No.: US 2017/0334598 A1
(43) Pub. Date: Nov. 23, 2017

(54) Packaging for Sanitary Ware

(71) Applicant: Mountainside Investment Group, LLC, Weslaco, TX (US)

(72) Inventors: Abraham Tanus, Weslaco, TX (US); Jose Daniel Alanis Garza, Weslaco, TX (US); John Clayton Evans, Weslaco, TX (US); Edgar David Arellano-Robles, Weslaco, TX (US); Jorge Alberto Algraves-Yarza, Weslaco, TX (US); Sarah Tanus, Weslaco, TX (US)

(21) Appl. No.: 15/600,621

(22) Filed: May 19, 2017

Related U.S. Application Data
(60) Provisional application No. 62/339,672, filed on May 20, 2016.

(51) Int. Cl. B65D 5/49; B65D 1/36; B65B 23/20; B67B 5/03; B65D 1/24; B65D 1/34

(52) U.S. Cl. CPC B65D 5/4803; B67B 5/03; B65D 1/246; B65D 1/36; B65B 23/20; B65D 1/24; B65D 5/48026; B65D 1/34

(57) ABSTRACT

A sanitary ware package includes a first packaging member configured to receive a first portion of toilet. The first packaging member has a plurality of perimeter surfaces, an outer surface, and an inner surface. The package further includes a second packaging member configured to receive a second portion of the toilet. The second packaging member has a plurality of perimeter surfaces, an outer surface, and an inner surface. Each packaging member includes an aperture passing through the packaging member from the outer surface of the packaging member to at least one of a cavity of the packaging member and the inner surface of the packaging member. The aperture of the first packaging member and the aperture of the second packaging member may be aligned.

### CROSS-REFERENCE TO RELATED APPLICATION

This application claims the benefit of U.S. Provisional Patent Application No. 62/339,672, filed May 20 2016, entitled “Packaging for Sanitary Ware,” the entirety of which is hereby incorporated by reference.

### BACKGROUND

The present disclosure relates to packaging and more specifically the packaging that is provided to protect a toilet or other sanitary ware following manufacture. Since the body of toilets and other sanitary ware is often made from a breakable material such as vitreous china, or porcelain, it can be challenging to safely ship and store these items. Current packaging designs often include a cardboard shell or box that encases the toilet, along with multiple cardboard inserts to secure the toilet within the cardboard shell.

### SUMMARY

The problems presented by packaging for sanitary ware are solved by the systems and methods described herein. In one illustrative embodiment, a package for sanitary ware includes a first packaging member configured to receive a first portion of toilet. The first packaging member has a plurality of perimeter surfaces, an outer surface, and an inner surface. The package further includes a second packaging member configured to receive a second portion of the toilet. The second packaging member has a plurality of perimeter surfaces, an outer surface, and an inner surface.

In another embodiment, a method of packaging a toilet includes capturing the toilet between a first packaging member and a second packaging member. The method further includes aligning an aperture in the first packaging member with an aperture in the second packaging member to allow visible inspection of a portion of the toilet through the aligned apertures.

Other objects, features, and advantages of the illustrative embodiments will become apparent with reference to the drawings, detailed description, and claims that follow.

### BRIEF DESCRIPTION OF THE DRAWINGS

FIG. 1 illustrates an isometric upper left view of a sanitary ware package according to an illustrative embodiment, the sanitary ware package having a first packaging member and a second packaging member;

FIG. 2 illustrates an isometric lower right view of the sanitary ware package of FIG. 1;

FIG. 3 illustrates an isometric upper left view of the second packaging member of FIG. 1;

FIG. 4 illustrates an isometric upper left view of the second packaging member of FIG. 1 with a toilet inserted into the second packaging member;

FIG. 5 illustrates a left side view of the sanitary ware package of FIG. 1;

FIG. 6 illustrates a left side view of the sanitary ware package of FIG. 1 in an embodiment where the first packaging member and the second packaging member are secured by straps;

FIG. 7 illustrates a left side view of the sanitary ware package of FIG. 1 in an embodiment where the first packaging member and the second packaging member are at least partially covered by shrinkable film;

FIG. 8 illustrates a left side view of the sanitary ware package of FIG. 1 in an embodiment where the first packaging member and the second packaging member are at least partially covered by a cardboard sleeve or box;

FIG. 9 illustrates an isometric upper left view of a sanitary ware package according to an illustrative embodiment, the sanitary ware package having a first packaging member and a second packaging member;

FIG. 10 illustrates an isometric lower right view of the sanitary ware package of FIG. 9;

FIG. 11 illustrates an isometric upper left view of the second packaging member of FIG. 9;

FIG. 12 illustrates an isometric upper left view of the second packaging member of FIG. 9 with a toilet inserted into the second packaging member;

FIG. 13 illustrates a left side view of the sanitary ware package of FIG. 9;

FIG. 14 illustrates a left side view of the sanitary ware package of FIG. 9 in an embodiment where the first packaging member and the second packaging member are secured by straps;

FIG. 15 illustrates a left side view of the sanitary ware package of FIG. 9 in an embodiment where the first packaging member and the second packaging member are at least partially covered by shrinkable film; and

FIG. 16 illustrates a left side view of the sanitary ware package of FIG. 9 in an embodiment where the first packaging member and the second packaging member are at least partially covered by a cardboard sleeve or box.

### DETAILED DESCRIPTION OF ILLUSTRATIVE EMBODIMENTS

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to”. Unless otherwise indicated, as used throughout this document, “or” does not require mutual exclusivity.

The large number of pieces associated with current packaging designs makes packaging operations inefficient. Current packaging arrangements also provide little protection for packed items, especially when breakable items are being packed. It is common in the sanitary ware industry for toilets and other products to suffer damage during shipping and storage. The packages presented and described herein provide additional protection for packed items and also allow shippers, retailers, and consumers to view various portions of a packed item to inspect for damage without unpacking the item.

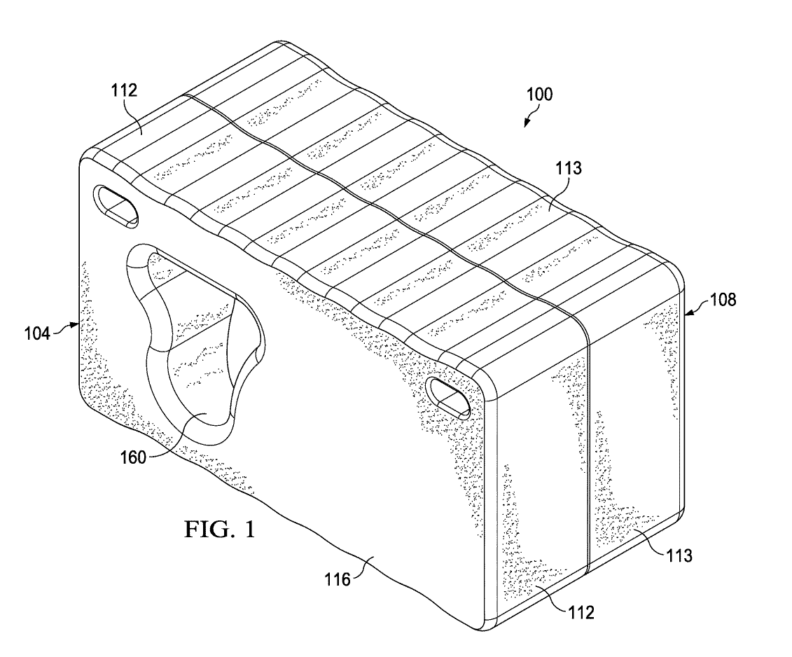

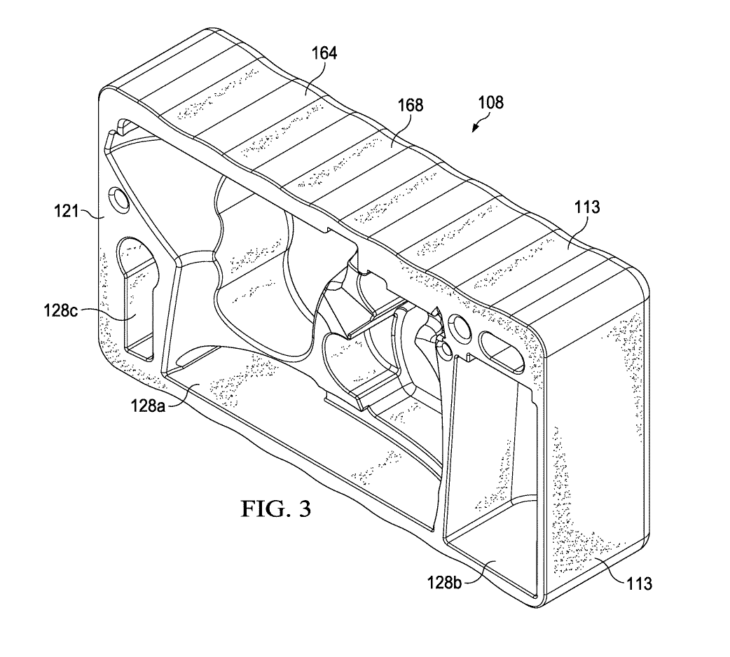

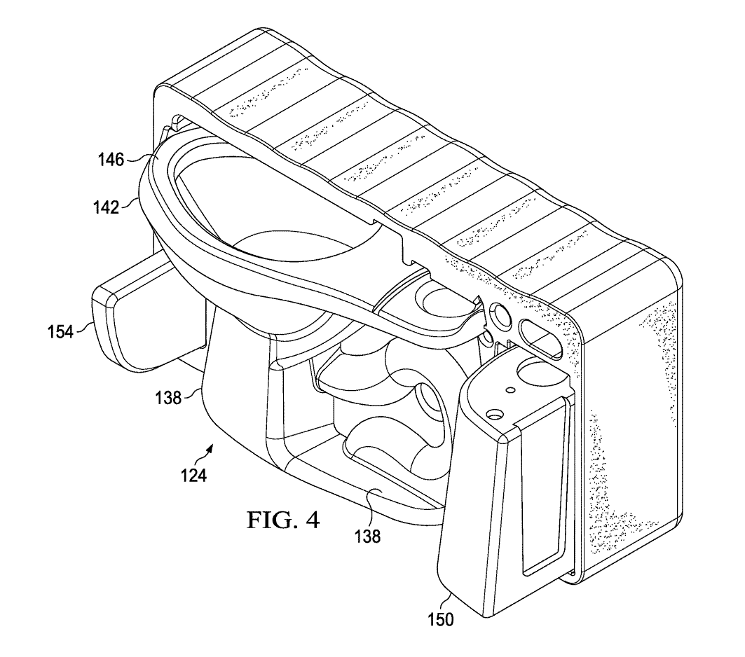

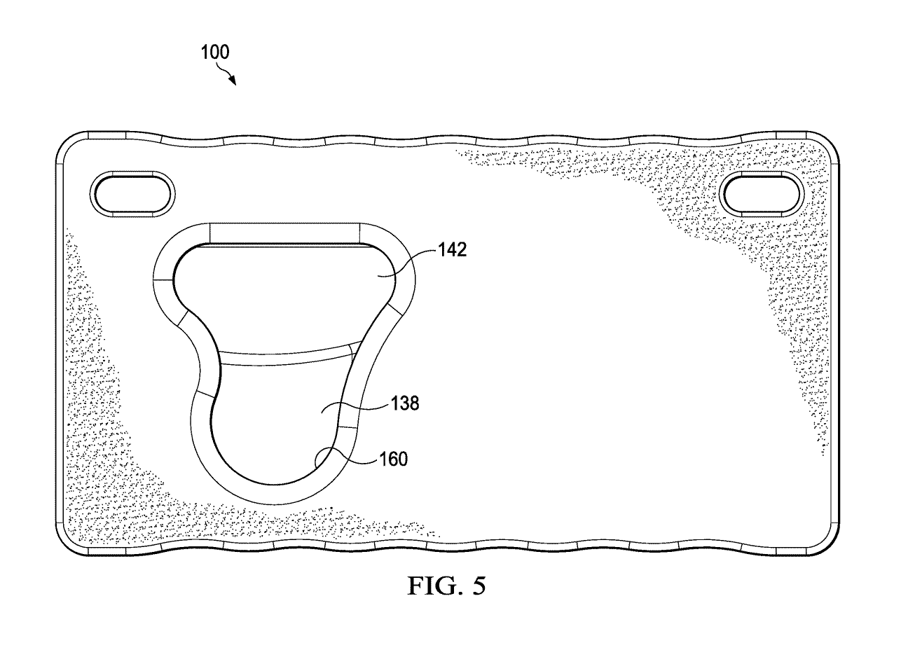

Referring to FIGS. 1-8, a package (or packaging) 100 according to an illustrative embodiment includes a first packaging member 104 and a second packaging member 108. The first packaging member 104 includes a plurality of perimeter surfaces 112, an outer surface 116, and an inner surface 120. The second packaging member 108 also includes a plurality of perimeter surfaces 113, an outer surface 117, and an inner surface 121. Each of the first and second packaging members 104, 108 includes at least one cavity to receive a portion of a toilet 124. More specifically, the second packaging member 108 includes at least one cavity 128a, and in the embodiment illustrated in FIGS. 1-8, additional cavities 128b and 128c to receive a portion or portions of the toilet 124 (see FIGS. 3 and 4). Referring more specifically to FIG. 4, the cavity 128a of the second packaging member 108 is configured to receive a portion of the toilet 124, which may include a body 138, a bowl 142, and a bowl lid 146 of the toilet 124. The cavity 128b may be configured to receive a tank 150 of the toilet, and the cavity 128c may be configured to receive a tank lid 154 of the toilet 124. The size and shape of each cavity 128a, 128b, 128c, and the number of cavities included in the second packaging member 108 may vary depending on the particular toilet design for which the packaging is intended. Although not illustrated specifically in FIGS. 1-8, the first packaging member 104 includes similar cavities to those provided in second packaging member 108. The cavities of the first packaging member 104 may be configured to receive the same portions or components of toilet 124 as the cavities 128a, 128b, and 128c in second packaging member 108. Again, the shape, size, and number of cavities provided in first packaging member 104 may vary depending on the particular toilet design for which the packaging is intended. In the embodiment illustrated in FIGS. 1-8, the size, shape, and number of the cavities of the first packaging member 104 (including the depth that each cavity extends from the inner surface 120 of the first packaging member 104), is the same as the size, shape, and number of the cavities 128a, 128b, 128c of the second packaging member 108. However, in some embodiments the sizes, shapes and number of the cavities of one packaging member may vary relative to those of the other packaging member. In one particular embodiment that is not illustrated, the size of each packaging member may be different than the other, resulting in cavities in one of the packaging members having a greater depth and different shapes than cavities in the other packaging member.

In the embodiment illustrated in FIGS. 1-8, the first packaging member 104 includes at least one aperture 160 passing through the first packaging member 104 from the outer surface 116 of the first packaging member 104 to at least one of the cavities (not shown, but see similarly positioned cavities 128a, 128b, and 128c of the second packaging member 108). The aperture 160 may instead or may also extend from the outer surface 116 to the inner surface 120 of the first packaging member 104. In other words, some portions of the aperture 160 may extend from the outer surface 116 to the inner surface 120, and some portions of the aperture 160 may extend from the outer surface 116 to one of the cavities.

Similarly, the second packaging member 108 includes at least one aperture 161 passing through the second packaging member 108 from the outer surface 117 of the second packaging member 108 to at least one of the cavities 128a, 128b, and 128c of the second packaging member 108. The aperture 161 of the second packaging member 108 may instead or may also extend from the outer surface 117 to the inner surface 121 of the second packaging member 108. In other words, some portions of the aperture 161 of the second packaging member 108 may extend from the outer surface 117 to the inner surface 121, and some portions of the aperture 161 may extend from the outer surface 117 to one of the cavities 128a, 128b, 128c.

While the embodiment illustrated in FIGS. 1-8 includes only one aperture 160 for first packaging member 104 and one aperture 161 for second packaging member 108, multiple apertures may be provided in each of the packaging members 104, 108. Each aperture is configured to allow viewing of a portion of the toilet 124 without removing the package 100 from the toilet 124. In FIGS. 1-8, the aperture 160 of the first packaging member 104 and the aperture 161 of the second packaging member 108 are both positioned, sized and shaped to allow viewing of a portion of the body 138 of the toilet 124. The aperture 160 of the first packaging member 104 and the aperture 161 of the second packaging member 108 are aligned such that, if the toilet were not present and the package 100 were assembled, the alignment of the apertures would provide a view through the package 100.

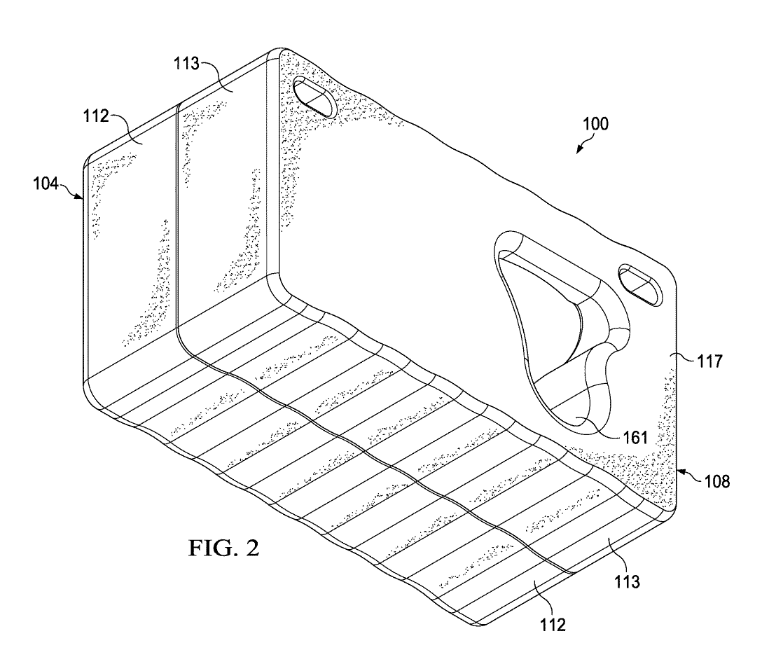

At least one of the perimeter surfaces 112 of the first packaging member 104 and at least one of the perimeter surfaces 113 of the second packaging member 108 includes a plurality of peaks 164 and valleys 168. Preferably, the peaks 164 and valleys 168 of the first packaging member 104 are aligned with the peaks 164 and valleys 168 of the second packaging member 108 when the package 100 is in an assembled position. In the embodiment illustrated in FIGS. 1 and 2, the peaks 164 and valleys 168 are present on only two of the perimeter surfaces 113, each of which is not adjacent to but rather opposite the other. The perimeter surfaces 113 on which the peaks 164 and valley 168 are disposed are the longer two surfaces, since it is these surfaces that likely will come into contact with a surface upon which the package will rest during storage, shipping, or while on display at a store. The extension of the peaks 164 beyond other portions of the applicable perimeter surface 113 allows the peaks 164 (and not the valleys 168) to contact the surface upon which the package 100 rests, which allows for greater absorption of impact or other forces that may be transmitted to the package 100. This is particularly true when the package is constructed from a material that has good energy absorption properties.

Although the peaks 164 and valleys 168 may be present on only two perimeter surfaces 112, 113 of the first and second packaging members 104, 108, the peaks 164 and valleys 168 could instead be present on any particular number of the perimeter surfaces 112, 113, or even all of the perimeter surfaces 112, 113.

The first and second packaging members 104, 108 may be constructed from any durable material, but in one embodiment each may be molded or otherwise formed of expanded polystyrene (EPS). In another embodiment, the first and second packaging members may be constructed of molded cellulose fiber pulp. Still another embodiment includes packaging members constructed from cardboard that may include a honeycomb core. The honeycomb core may also be made from a paper-based material such as cardboard.

In operation, the package 100 receives and protects sanitary ware such as the toilet 124. To package the toilet 124, the toilet 124 is placed into the cavities of the second packaging member 108 as best illustrated in FIG. 4. More specifically, the cavity 128a of the second packaging member 108 receives the portion of the toilet 124 that includes the body 138, the bowl 142, and the bowl lid 146. The cavity 128b of the second packaging member 108 receives the tank 150, and the cavity 128c of the second packaging member 108 receives the tank lid 154. The first packaging member 104 is then positioned next to the toilet such that the corresponding cavities of the first packaging member 104 receive the corresponding portions of the toilet 124 mentioned above. As the exposed portion of the toilet (FIG. 4) is received by the cavities of the first packaging member 104, the first packaging member 104 is moved toward the second packaging member 108 until the inner surface 120 of the first packaging member 104 contacts or is proximate to the inner surface 121 of the second packaging member 108. In this assembled position, which is illustrated in FIGS. 1 and 2, the toilet 124 is contained within the package 100 and is protected.

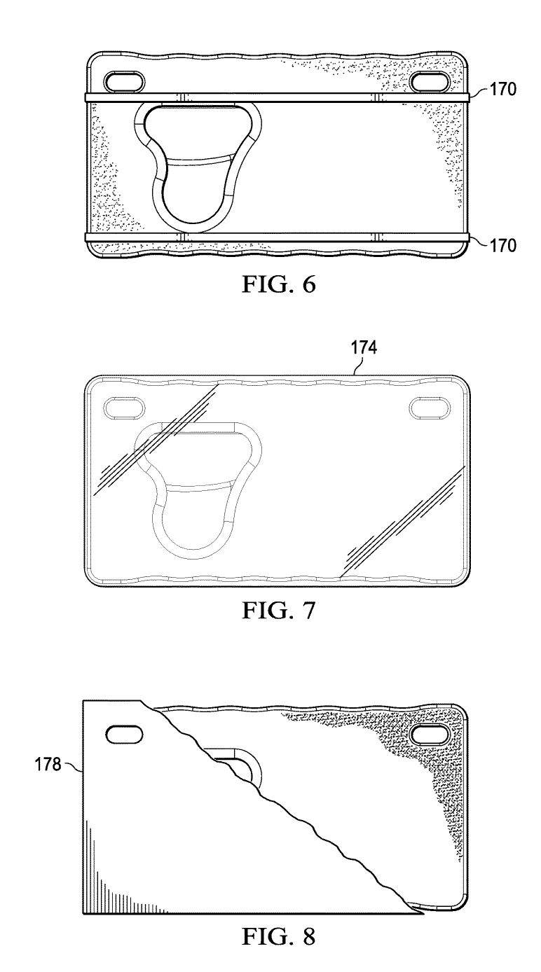

After placing the first and second packaging members 104, 108 in the assembled position, the packaging members can be secured by positioning a plurality of straps 170 around the first and second packaging member 104, 108 as illustrated in FIG. 6. Alternatively or in addition to the straps 170, a shrinkable film 174 or other material may be placed around the first and second packaging member 104, 108 as illustrated in FIG. 7. Alternatively or in addition to the straps 170 and the shrinkable film 174, a cardboard sleeve 178 or box may be provided to receive all of or a portion of the first and second packaging members 104, 108 as illustrated in FIG. 8.

The presence of the aperture 160 of the first packaging member 104 and the aperture 161 of the second packaging member 108 allows shipping personnel, consumers, or other persons to view the body 138 of the toilet 124 without removing any portion of the package 100. Such viewing not only allows the color and style of the toilet to be displayed, but also allows interested persons to determine if the portion of the toilet being viewed has sustained any damage during shipping or storage.

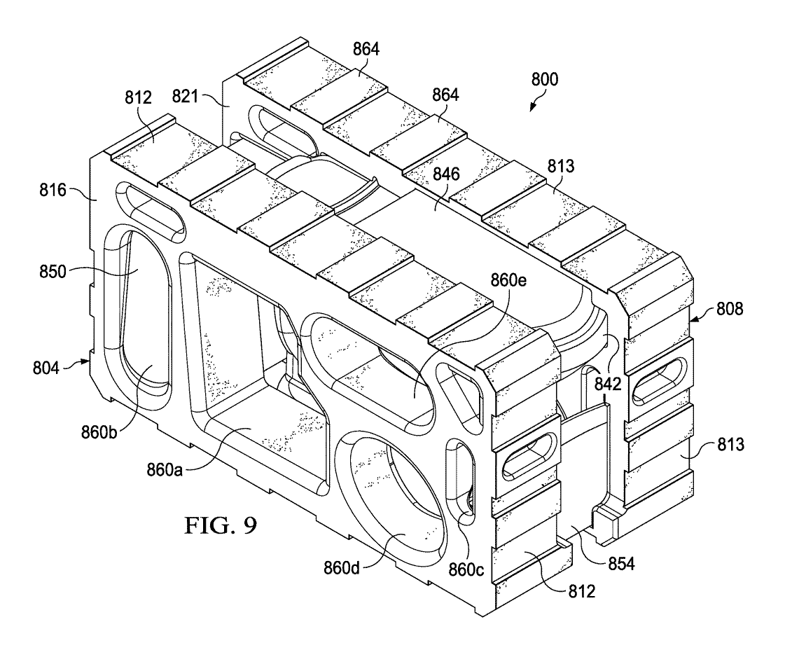

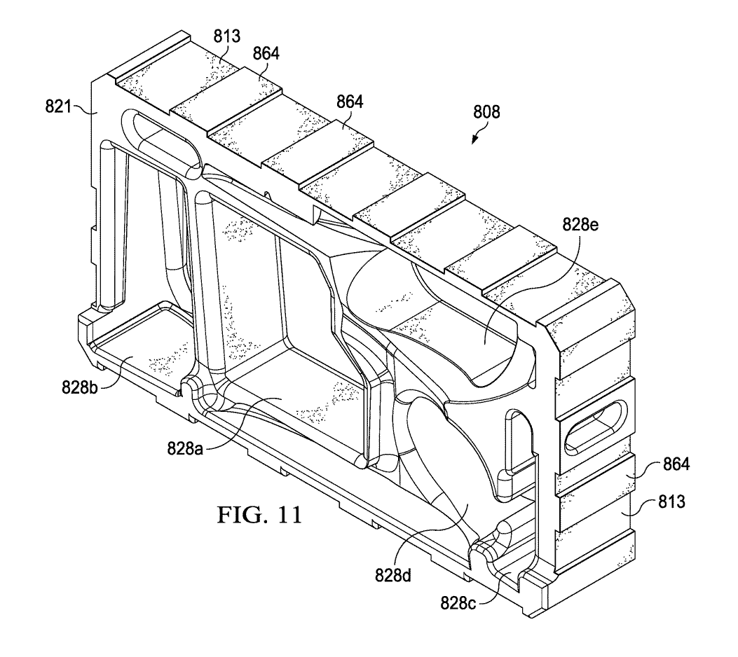

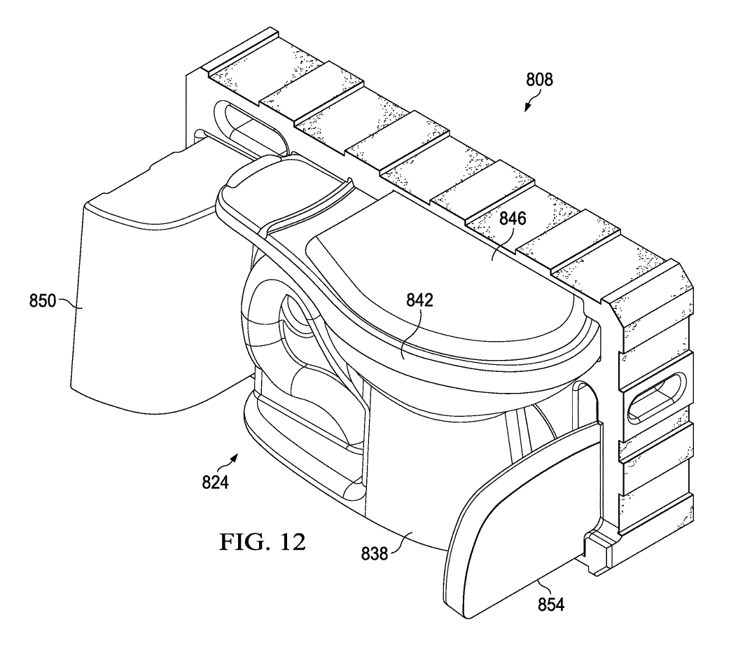

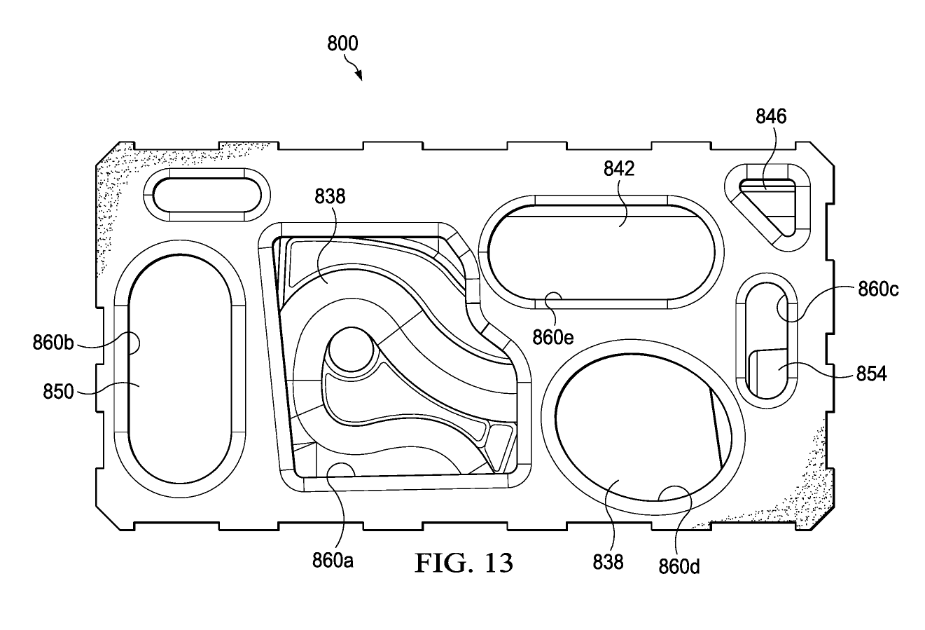

Referring to FIGS. 9-16 a package (or packaging) 800 according to an illustrative embodiment includes a first packaging member 804 and a second packaging member 808. The first packaging member 804 includes a plurality of perimeter surfaces 812, an outer surface 816, and an inner surface 820. The second packaging member 808 also includes a plurality of perimeter surfaces 813, an outer surface 817, and an inner surface 821. Each of the first and second packaging members 804, 808 includes at least one cavity to receive a portion of a toilet 824. More specifically, the second packaging member 808 includes at least one cavity 828a, and in the embodiment illustrated in FIGS. 9-16, additional cavities 828b, 828c, 828d, and 828e to receive a portion or portions of the toilet 824 (see FIGS. 11 and 12). Referring more specifically to FIG. 12, the cavity 828a of the second packaging member 808 is configured to receive a portion of the toilet 824, which may include a body 838 of the toilet 824. The cavity 828b may be configured to receive a tank 850 of the toilet 824, and the cavity 828c may be configured to receive a tank lid 854 of the toilet 824. The cavity 828d may be configured to receive a portion of a bowl 842 or the body 838 of the toilet 824. The cavity 828e may be configured to receive a portion of the bowl 842 and a bowl lid 846 of the toilet 824. The size and shape of each cavity 828a, 828b, 828c, 828d, 828e and the number of cavities included in the second packaging member 808 may vary depending on the particular toilet design for which the package 800 is intended. Although not shown specifically in FIGS. 9-16, the first packaging member 804 includes similar cavities to those provided in second packaging member 808. The cavities of the first packaging member 804 may be configured to receive the same portions or components of toilet 824 as the cavities 828a, 828b, 828c, 828d, and 828e in second packaging member 808. Again, the shape, size, and number of cavities provided in first packaging member 804 may vary depending on the particular toilet design for which the packaging is intended. In the embodiment illustrated in FIGS. 9-16, the size, shape, and number of the cavities of the first packaging member 804 (including the depth that each cavity extends from the inner surface 820 of the first packaging member 804), is the same as the size, shape, and number of the cavities 828a, 828b, 828c, 828d, 828e of the second packaging member 808. However, in some embodiments the sizes, shapes and number of the cavities of one packaging member may vary relative to those of the other packaging member. In one particular embodiment that is not illustrated, the size of each packaging member may be different than the other, resulting in cavities in one of the packaging members having a greater depth and different shapes than cavities in the other packaging member.

In the embodiment illustrated in FIGS. 9-16, the first packaging member 804 includes at least a plurality of apertures 860a, 860b, 860c, 860d, 860e (referred to collectively as apertures 860) passing through the first packaging member 804 from the outer surface 816 of the first packaging member 804 to at least one of the cavities (not shown, but see similarly positioned cavities 828a, 828b, 828c, 828d, and 828e of the second packaging member 808). The apertures 860a, 860b, 860c, 860d, 860e may instead or may also extend from the outer surface 816 to the inner surface 820 of the first packaging member 804. In other words, some portions of the apertures 860a, 860b, 860c, 860d, 860e may extend from the outer surface 816 to the inner surface 820, and some portions of the apertures 860a, 860b, 860c, 860d, 860e may extend from the outer surface 816 to one of the cavities.

Similarly, the second packaging member 808 includes a plurality of apertures 860a, 861b, 861c, 861d, 861e passing through the second packaging member 808 from the outer surface 817 of the second packaging member 808 to at least one of the cavities 828a, 828b, 828c, 828d, and 828e of the second packaging member 808. The apertures 860a, 861b, 861c, 861d, 861e of the second packaging member 808 may instead or may also extend from the outer surface 817 to the inner surface 821 of the second packaging member 808. In other words, some portions of the aperture 860a, 861b, 861c, 861d, 861e of the second packaging member 808 may extend from the outer surface 817 to the inner surface 821, and some portions of the apertures 860a, 861b, 861c, 861d, 861e may extend from the outer surface 817 to one of the cavities 828a, 828b, 828c, 828d, and 828e.

While the embodiment illustrated in FIGS. 9-16 includes five apertures 860 for first packaging member 804 and five apertures 861 for second packaging member 808, variations in the number of apertures provided is also possible. Each aperture is configured to allow viewing of a portion of the toilet 824 without removing the package 800 from the toilet 824. In FIGS. 9-16, the aperture 860a of the first packaging member 804 and the corresponding aperture 861a of the second packaging member 808 are both positioned, sized and shaped to allow viewing of a portion of the body 838 of the toilet 824. The aperture 860b of the first packaging member 804 and the corresponding aperture 861b of the second packaging member 808 are both positioned, sized and shaped to allow viewing of a portion of the tank 850 of the toilet 824. The aperture 860c of the first packaging member 804 and the corresponding aperture 861c of the second packaging member 808 are both positioned, sized and shaped to allow viewing of a portion of the tank lid 854 of the toilet 824. The aperture 860d of the first packaging member 804 and the corresponding aperture 861d of the second packaging member 808 are both positioned, sized and shaped to allow viewing of a portion of the body 838 of the toilet 824. The aperture 860e of the first packaging member 804 and the corresponding aperture 861e of the second packaging member 808 are both positioned, sized and shaped to allow viewing of a portion of the bowl 842 and the bowl lid 846 of the toilet 824.

The apertures 860 of the first packaging member 804 and the corresponding apertures 861 of the second packaging member 808 are aligned such that, if the toilet were not present and the package 800 were assembled, the alignment of the apertures would provide a view through the package 800.

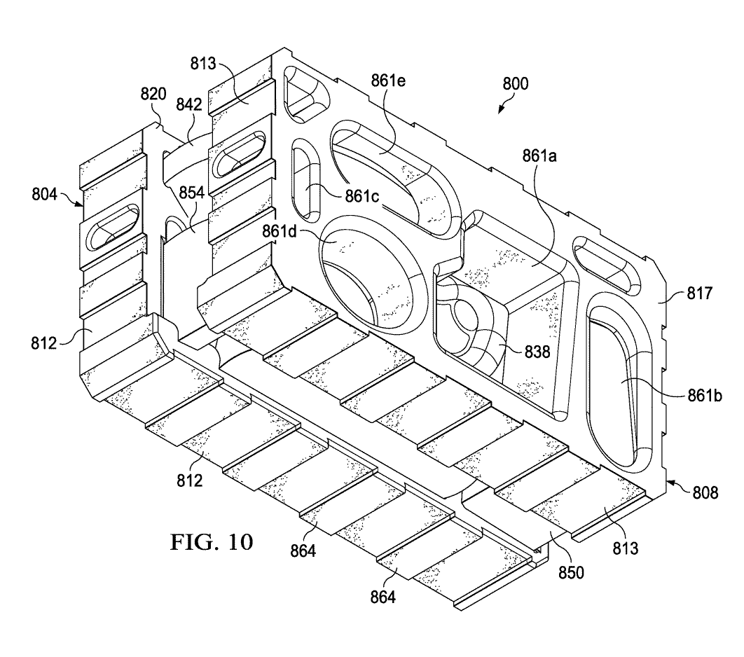

At least one of the perimeter surfaces 812 of the first packaging member 804 and at least one of the perimeter surfaces 813 of the second packaging member 808 include a plurality of projections 864. Preferably, the projections 864 of the first packaging member 804 are aligned with the projections 864 of the second packaging member 808 when the package 800 is in an assembled position. In the embodiment illustrated in FIGS. 9 and 10, the projections 864 are present on all of the perimeter surfaces 812, 813. The extension of the projections 864 beyond other portions of the perimeter surfaces 812, 813 allows the projections 864 to contact a surface upon which the package 800 rests, which allows for greater absorption of impact or other forces that may be transmitted to the package 800. This is particularly true when the package is constructed from a material that has good energy absorption properties. The projections 864 illustrated in FIGS. 9-16 are planar, but alternatively, the projections 864 may be provided in rounded or other non-planar configuration.

The first and second packaging members 804, 808 may be constructed from any durable material, but in one embodiment each may be molded or otherwise formed of EPS. In another embodiment, the first and second packaging members may be constructed of molded cellulose fiber pulp. Still another embodiment includes packaging members constructed from cardboard that may include a honeycomb core. The honeycomb core may also be made from a paper-based material such as cardboard.

In operation, the package 800 receives and protects sanitary ware such as the toilet 824. To package the toilet 824, the toilet 824 is placed into the cavities of the second packaging member 808 as best illustrated in FIG. 12. More specifically, the cavity 828a of the second packaging member 808 receives a portion of the body 838. The cavity 828b receives a portion of the tank 850 of the toilet 824, and the cavity 828c receives a portion of the tank lid 854. The cavity 828d receives a portion of the bowl 842 and the body 838, while the cavity 828e receives a portion of the bowl 842 and the bowl lid 846. The first packaging member 804 is then positioned next to the toilet such that the corresponding cavities of the first packaging member 804 receive the corresponding portions of the toilet 824 mentioned above. As the exposed portion of the toilet (FIG. 12) is received by the cavities of the first packaging member 804, the first packaging member 804 is moved toward the second packaging member 808 until the first and second packaging members 804, 808 are in the assembled position shown in FIGS. 9 and 10. In this assembled position, the toilet 824 is protected by the package 800, yet the package does not completely surround the toilet 824 or provide as much coverage as the package 100 illustrated in FIGS. 1-8.

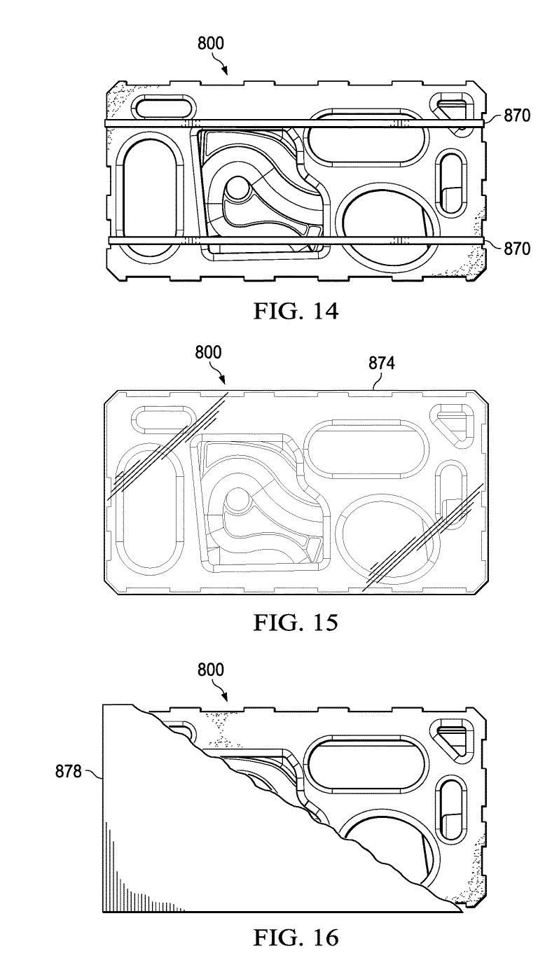

After placing the first and second packaging members 804, 808 in the assembled position, the packaging members can be secured by positioning a plurality of straps 870 around the first and second packaging member 804, 808 as illustrated in FIG. 14. Alternatively or in addition to the straps 870, a shrinkable film 874 or other material may be placed around the first and second packaging member 804, 808 as illustrated in FIG. 15. Alternatively or in addition to the straps 870 and the shrinkable film 874, a cardboard sleeve 878 or box may be provided to receive all of or a portion of the first and second packaging members 804, 808 as illustrated in FIG. 16.

The presence of the apertures 860 of the first packaging member 804 and the corresponding apertures 861 of the second packaging member 808 allows shipping personnel, consumers, or other persons to view the body 838, bowl 842, bowl lid 846, tank 850, and tank lid 854 of the toilet 124 without removing any portion of the package 100. Such viewing not only allows the color and style of the toilet to be displayed, but also allows interested persons to determine if the portion of the toilet being viewed has sustained any damage during shipping or storage.

In addition to the Figures described herein, the following examples represent embodiments of the present disclosure:

Example 1. A package for sanitary ware comprising:
a first packaging member configured to receive a first portion of toilet, the first packaging member having a plurality of perimeter surfaces, an outer surface, and an inner surface; and
a second packaging member configured to receive a second portion of the toilet, the second packaging member having a plurality of perimeter surfaces, an outer surface, and an inner surface.

Example 2. The package of example 1, wherein the inner surface of the second packaging member mates with the inner surface of the first packaging member when the first and second packaging members receive the toilet and are placed in a packaged position.

Example 3. The package of example 1, wherein the inner surface of the second packaging member is spaced apart from the inner surface of the first packaging member when the first and second packaging members receive the toilet and are placed in a packaged position.

Example 4. The package of any of examples 1-3, wherein:
at least one cavity is formed in the inner surface of the first packaging member to receive the first portion of the toilet; and
at least one cavity is formed in the inner surface of the second packaging member to receive the second portion of the toilet.

Example 5. The package of example 4, wherein the first packaging member further comprises an aperture passing through the first packaging member from the outer surface of the first packaging member to at least one of the cavity of the first packaging member and the inner surface of the first packaging member.

Example 6. The package of example 4, wherein:
the first packaging member having an aperture passing through the first packaging member from the outer surface of the first packaging member to at least one of the cavity of the first packaging member and the inner surface of the first packaging member; and
the second packaging member having an aperture passing through the second packaging member from the outer surface of the second packaging member to at least one of the cavity of the second packaging member and the inner surface of the second packaging member.

Example 7. The package of example 6, wherein the aperture of the first packaging member is in alignment with the aperture of the second packaging member when the packaging members are placed in a packaged position.

Example 8. The package of examples 6 or 7, wherein the apertures of the first and second packaging members are configured to allow viewing of at least one of a body, a bowl, a bowl lid, a tank, and a tank lid of the toilet when the packaging members receive the toilet and are placed in a packaged position.

Example 9. The package of example 4, wherein:
the first packaging member having a plurality of apertures passing through the first packaging member, each of the plurality of apertures passing from the outer surface of the first packaging member to at least one of the cavity of the first packaging member and the inner surface of the first packaging member;
the second packaging member having a plurality of apertures passing through the second packaging member, each of the plurality of apertures passing from the outer surface of the second packaging member to at least one of the cavity of the second packaging member and the inner surface of the second packaging member; and
each aperture of the first packaging member is in alignment with one of the apertures of the second packaging member when the packaging members are placed in a packaged position.

Example 10. The package of example 9, wherein the apertures of the first and second packaging members are configured to allow viewing of at least two of a body, a bowl, a bowl lid, a tank, and a tank lid of the toilet when the packaging members receive the toilet and are placed in a packaged position.

Example 11. The package of example 9, wherein the apertures of the first and second packaging members are configured to allow viewing of a body, a bowl, a bowl lid, a tank, and a tank lid of the toilet when the packaging members receive the toilet and are placed in a packaged position.

Example 12. The package of any of examples 1-11, wherein at least one of the perimeter surfaces of the first packaging member and least one of the perimeter surfaces of the second packaging members includes a plurality of peaks and valleys, the plurality of peaks configured to contact a surface on which the first and second packaging members rest.

Example 13. The package of any of examples 1-11, wherein at least one of the perimeter surfaces of the first packaging member and least one of the perimeter surfaces of the second packaging members includes a plurality of projections, the plurality of projections configured to contact a surface on which the first and second packaging members rest.

Example 14. The package of example 13, wherein a contact surface of each raised projection is substantially planar.

Example 15. The package of any of examples 1-14, wherein the first and second packaging members are constructed of expanded polystyrene.

Example 16. The package of any of examples 1-14, wherein the first and second packaging members are constructed of molded cellulose fiber pulp.

Example 17. The package of any of examples 1-14 or 16, wherein the first and second packaging members are constructed from cardboard that includes a honeycomb core.

Example 18. The package of any of examples 1-17, wherein the first and second packaging members are held in a packaged position by a plurality of straps.

Example 19. The package of any of examples 1-18, wherein the first and second packaging members are held in a packaged position by a shrink wrap disposed around at least a portion of the first and second packaging members.

Example 20. The package of any of examples 1-19, wherein the first and second packaging members are held in a packaged position by a cardboard sleeve or box that receives the first and second packaging members.

Example 21. A method of packaging a toilet comprising:
capturing the toilet between a first packaging member and a second packaging member;
aligning an aperture in the first packaging member with an aperture in the second packaging member to allow visible inspection of a portion of the toilet through the aligned apertures.

Example 22. The method of example 21, wherein the first packaging member is the same size as the second packaging member.

Example 23. The method of example 21 or 22, wherein the first packaging member is a mirror image of the second packaging member.

Example 24. The method of any of examples 21-23, wherein the aperture of the first packaging member is one of a plurality of apertures disposed in the first packaging member.

Example 25. The method of any of examples 21-24, wherein the aperture of the second packing member is one of a plurality of apertures disposed in the second packaging member.

Example 26. The method of any of examples 21-25, wherein the number of the plurality of apertures in the second packaging member is equal to the number of the plurality of apertures in the first packaging member.

Example 27. The method of any of examples 21-26, wherein each of the plurality of apertures in the second packaging member is aligned with one of the plurality of apertures in the first packaging member.

Example 28. The method of any of examples 21-27, wherein each of the aligned pairs of apertures in the first and second packaging members allows visible inspection of the toilet.

It should be apparent from the foregoing that an invention having significant advantages has been provided. While the invention is shown in only a few of its forms, it is not limited to only these embodiments but is susceptible to various changes and modifications without departing from the spirit thereof.

What is claimed is:

1. A package for sanitary ware comprising:
a first packaging member configured to receive a first portion of toilet, the first packaging member having a plurality of perimeter surfaces, an outer surface, and an inner surface; and
a second packaging member configured to receive a second portion of the toilet, the second packaging member having a plurality of perimeter surfaces, an outer surface, and an inner surface.

2. The package of claim 1, wherein the inner surface of the second packaging member mates with the inner surface of the first packaging member when the first and second packaging members receive the toilet and are placed in a packaged position.

3. The package of claim 1, wherein the inner surface of the second packaging member is spaced apart from the inner surface of the first packaging member when the first and second packaging members receive the toilet and are placed in a packaged position.

4. The package of claim 1, wherein:
at least one cavity is formed in the inner surface of the first packaging member to receive the first portion of the toilet; and
at least one cavity is formed in the inner surface of the second packaging member to receive the second portion of the toilet.

5. The package of claim 4, wherein the first packaging member further comprises:
an aperture passing through the first packaging member from the outer surface of the first packaging member to at least one of the cavity of the first packaging member and the inner surface of the first packaging member.

6. The package of claim 4, wherein:
the first packaging member having an aperture passing through the first packaging member from the outer surface of the first packaging member to at least one of the cavity of the first packaging member and the inner surface of the first packaging member; and
the second packaging member having an aperture passing through the second packaging member from the outer surface of the second packaging member to at least one of the cavity of the second packaging member and the inner surface of the second packaging member.

7. The package of claim 6, wherein the aperture of the first packaging member is in alignment with the aperture of the second packaging member when the packaging members are placed in a packaged position.

8. The package of claim 7, wherein the apertures of the first and second packaging members are configured to allow viewing of at least one of a body, a bowl, a bowl lid, a tank, and a tank lid of the toilet when the packaging members receive the toilet and are placed in a packaged position.

9. The package of claim 4, wherein:
the first packaging member having a plurality of apertures passing through the first packaging member, each of the plurality of apertures passing from the outer surface of the first packaging member to at least one of the cavity of the first packaging member and the inner surface of the first packaging member;
the second packaging member having a plurality of apertures passing through the second packaging member, each of the plurality of apertures passing from the outer surface of the second packaging member to at least one of the cavity of the second packaging member and the inner surface of the second packaging member; and
each aperture of the first packaging member is in alignment with one of the apertures of the second packaging member when the packaging members are placed in a packaged position.

10. The package of claim 9, wherein the apertures of the first and second packaging members are configured to allow viewing of at least two of a body, a bowl, a bowl lid, a tank, and a tank lid of the toilet when the packaging members receive the toilet and are placed in a packaged position.

11. The package of claim 9, wherein the apertures of the first and second packaging members are configured to allow viewing of a body, a bowl, a bowl lid, a tank, and a tank lid of the toilet when the packaging members receive the toilet and are placed in a packaged position.

12. The package of claim 1, wherein at least one of the perimeter surfaces of the first packaging member and least one of the perimeter surfaces of the second packaging members includes a plurality of peaks and valleys, the plurality of peaks configured to contact a surface on which the first and second packaging members rest.

13. The package of claim 1, wherein at least one of the perimeter surfaces of the first packaging member and least one of the perimeter surfaces of the second packaging members includes a plurality of projections, the plurality of projections configured to contact a surface on which the first and second packaging members rest.

14. The package of claim 13, wherein a contact surface of each raised projection is substantially planar.

15. The package of claim 1, wherein the first and second packaging members are constructed of expanded polystyrene.

16. The package of claim 1, wherein the first and second packaging members are constructed of molded cellulose fiber pulp.

17. The package of claim 1, wherein the first and second packaging members are constructed from cardboard that includes a honeycomb core.

18. The package of claim 1, wherein the first and second packaging members are held in a packaged position by a plurality of straps.

19. The package of claim 1, wherein the first and second packaging members are held in a packaged position by a shrink wrap disposed around at least a portion of the first and second packaging members.

20. The package of claim 1, wherein the first and second packaging members are held in a packaged position by a cardboard sleeve or box that receives the first and second packaging members.

21. A method of packaging a toilet comprising:
capturing the toilet between a first packaging member and a second packaging member;
aligning an aperture in the first packaging member with an aperture in the second packaging member to allow visible inspection of a portion of the toilet through the aligned apertures.

22. The method of claim 21, wherein the first packaging member is the same size as the second packaging member.

23. The method of claim 21, wherein the first packaging member is a mirror image of the second packaging member.

24. The method of claim 21, wherein:
the aperture of the first packaging member is one of a plurality of apertures disposed in the first packaging member;
the aperture of the second packing member is one of a plurality of apertures disposed in the second packaging member;
the number of the plurality of apertures in the second packaging member is equal to the number of the plurality of apertures in the first packaging member;
each of the plurality of apertures in the second packaging member is aligned with one of the plurality of apertures in the first packaging member;
each of the aligned pairs of apertures in the first and second packaging members allows visible inspection of the toilet.
